(19) United States
(12) Patent Application Publication
(10) Pub. No.: US 2010/0241721 A1
(43) Pub. Date: Sep. 23, 2010

(54) Method and apparatus for setting up an audio conference connection

(75) Inventor: Feng Cha, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/795,527

(22) Filed: Jun. 7, 2010

Related U.S. Application Data
(63) Continuation of application No. PCT/CN2009/070237, filed on Jan. 21, 2009.

(30) Foreign Application Priority Data
Jan. 31, 2008 (CN) 200810006800.9

(51) Int. Cl. G06F 15/16; G06F 15/173

(52) U.S. Cl. 709/206; 709/227; 709/226

(57) ABSTRACT

A method for setting up an audio conference connection disclosed in an embodiment of the present invention includes: allocating at least two Media Servers (MSs), with the quantity of the MS dependent on the quantity of User Equipment (UE) involved in audio conference; selecting an MS as a root node MS, and treating the remaining MSs as leaf node MSs; allocating the UEs to the MSs, and setting up a connection between each UE and the MS that serves the UE; and setting up a connection between each leaf node MS and the root node MS. The present invention also discloses an apparatus for setting up an audio conference connection. The present invention enables concatenation of multiple MSs if a single MS is not enough for meeting the conference requirements, so as to implement a large conference with unlimited quantity of UE.

### CROSS-REFERENCE TO RELATED APPLICATIONS

This application is a continuation of International Application No. PCT/CN2009/070237, filed on Jan. 21, 2009, which claims priority to Chinese Patent Application No. 200810006800.9, filed on Jan. 31, 2008, both of which are hereby incorporated by reference in their entireties.

### FIELD OF THE INVENTION

The present invention relates to the field of communication technologies, and in particular, to a method and an apparatus for setting up an audio conference connection.

### BACKGROUND

Audio conference is also known as teleconference. It is an important prevalent service in the Next Generation Network (NGN) and the IP Multimedia Subsystem (IMS). Currently, in the telecom field, the audio conference system is primarily constructed on an IP MS. For example, as shown in FIG. 1, an audio conference system under the Session Initiation Protocol (SIP) includes a Media Server (MS) 101 and a SIP Application Server (AS) 102. The SIP AS102 is adapted to control the User Equipment (UE) 103 and the MS101, execute the conference logics and construct the conference signaling, maintain the resources on the MS101, and allocate resources for the calls. In the process of creating an audio conference, the UE involved in the conference originates a call to the SIP AS102 through the gateway 104, and the SIP AS102 originates a call to the MS101 to create an audio conference. Alternatively, the SIP AS102 can originate a conference actively. A common method of setting up an audio conference connection in the system shown in FIG. 1 is described below, supposing that the SIP AS originates the conference.

The SIP AS102 sends an INVITE (SIP call origination) message to the UE103. After going off-hook or picking up the phone, the UE103 returns a 200 OK (acknowledgement) message to the SIP AS102, with the Session Description Protocol (SDP) information of the UE103 carried in the message. The SDP information includes the IP address for receiving the audio packet, the port ID and the type of the processing media.

The SIP AS102 sends an INVITE message to the MS101, with the SDP information of the UE103 carried in the message. In this way, the MS101 can create a conference terminal for receiving and transmitting data according to the SDP information of the UE103, and allocate an IP port for receiving and another IP port for transmitting data, to the conference terminal. The conference terminal can be regarded as an entity for transmitting data between the audio processors located on the UE103 and the MS101.

After creating the conference terminal of the UE103, the MS sends a 200 OK message to the UE103 through SIP AS102, with the SDP information of the conference terminal carried in the message. After the UE103 and the corresponding conference terminal on the MS101 know the relevant information about the peer such as IP address and port ID of the peer, the UE103 and the MS101 can transmit data in between according to the peer SDP information.

Deficiencies in existing audio conference systems are described hereinafter.

In conventional systems, audio conference can be implemented on only one MS. Namely, no matter how many UEs are involved in the audio conference, all UEs of the conference are connected to only one MS, which requires the MS to have enough resources for supporting the whole conference. However, a general commercial MS has limited quantity of audio conference ports. When the operation is busy, one MS tends to operate multiple conferences, which occupy plenty of resources. Therefore, if the quantity of attendees of a conference goes far beyond the capacity of a single MS, it is impossible to create a conference with enough resources on the MS, and the conference has to be cancelled or the number of attendees has to be reduced. Consequently, the conference service is affected. In conventional systems, the capacity of resources on a single MS tends to limit the size of an audio conference and affect smooth progress of the audio conference.

### SUMMARY

The embodiments of the present invention provide a method and an apparatus for setting up audio conference connections, so as to create a large audio conference through multiple concatenated MSs.

A method for setting up audio conference connections provided in an embodiment of the present invention includes:

allocating at least two Media Servers (MSs), according to the quantity of terminals involved in an audio conference;

selecting one MS from the at least two MSs as a root node MS, and the remaining MS(s) as leaf node MS;

establishing communication between the root node MS and the leaf node MS(s); and

establishing communication between a terminal and the MS served for the terminal, wherein the process of establishing communication between a terminal and the MS served for the terminal further comprises: establishing communication between the terminal that needs to speak and the root node MS; and establishing communication between the terminal that needs not to speak and the leaf node MS.

Based on the previous technical solution, the present invention also discloses an apparatus for setting up an audio conference connection, including:

an allocating unit, adapted to allocate at least two Media Servers, MSs, according to the quantity of terminals involved in an audio conference, and select one MS from the at least two MSs as a root node MS, and the remaining MS(s) as leaf node MS;

a terminal communication unit, adapted to establish communication between a terminal and an MS served for the terminal; and

an MS communication unit, adapted to establish communication between the root node MS and the leaf node MS(s), wherein the terminal communication unit allocates terminals ready to speak onto the root node MS and allocates other terminals not ready to speak onto the leaf node MS.

Compared with conventional systems, the embodiments of the invention provide the benefits described hereinafter.

The embodiments of the present invention can concatenate multiple MSs to implement functions of a large conference without limiting the UE quantity in the case that a single MS is not enough, thus solving the inability of convening large conferences reliably in conventional systems for deficiency of MSs in the operation environment. The user can operate the conference on a large integrated virtual MS regardless of the conference size and the quantity of MSs on which the conference is distributed. The operators can deploy the MSs of a proper quantity according to the scale of the concurrent users. The existing MSs can be integrated into the technical solution under the present invention regardless of the manufacturer, only if they provide standard interfaces and capacity parameters.

### BRIEF DESCRIPTION OF THE DRAWINGS

FIG. 1 shows an exemplary architecture of a conventional audio conference.

FIG. 2 shows an exemplary architecture of a concatenated audio conference system according to an embodiment of the present invention.

FIG. 3 is an exemplary flowchart of a method for setting up a concatenated audio conference between MSs according to an embodiment of the present invention.

FIG. 4 is an exemplary flowchart of a method for setting up an audio conference connection between a UE with an MS according to an embodiment of the present invention.

FIG. 5 shows an exemplary flowchart of a dynamic concatenation method according to an embodiment of the present invention.

FIG. 6 is an exemplary flowchart of a method for switching the UE from the mute state to the speaking state according to an embodiment of the present invention.

FIG. 7 shows an exemplary architecture of an apparatus for setting up an audio conference connection according to an embodiment of the present invention.

FIG. 8 shows an exemplary architecture of an MS unit in the apparatus shown in FIG. 7 according to an embodiment of the present invention.

FIG. 9 shows an exemplary architecture of another MS unit in the apparatus shown in FIG. 7 according to an embodiment of the present invention.

FIG. 10 shows an exemplary architecture of another apparatus for setting up an audio conference connection according to an embodiment of the present invention.

### DETAILED DESCRIPTION

The present invention is hereinafter described in detail with reference to embodiments and accompanying drawings.

In a method for setting up audio conference connections according to an embodiment of the present invention, a SIP AS performs uniform management on all MSs in the system, and is responsible for allocating resources to such MSs. The MSs may involve different manufacturers. When the resources of a single MS are not enough for supporting the whole audio conference, the SIP AS can make two or more MSs into a tree topology. One of the MSs serves as a root node MS, and the remaining MSs serve as leaf node MSs in the conference of a tree structure. Afterward, the SIP AS allocates the UEs onto leaf node MSs or the root node MS, sets up a connection between every UE with the MS that serves that the UE and sets up a connection between every leaf node MS and the root node MS, thus accomplishing connections between all UEs. To put it simply, the audio conference connected through a tree structure may be called a “concatenated audio conference” hereinafter.

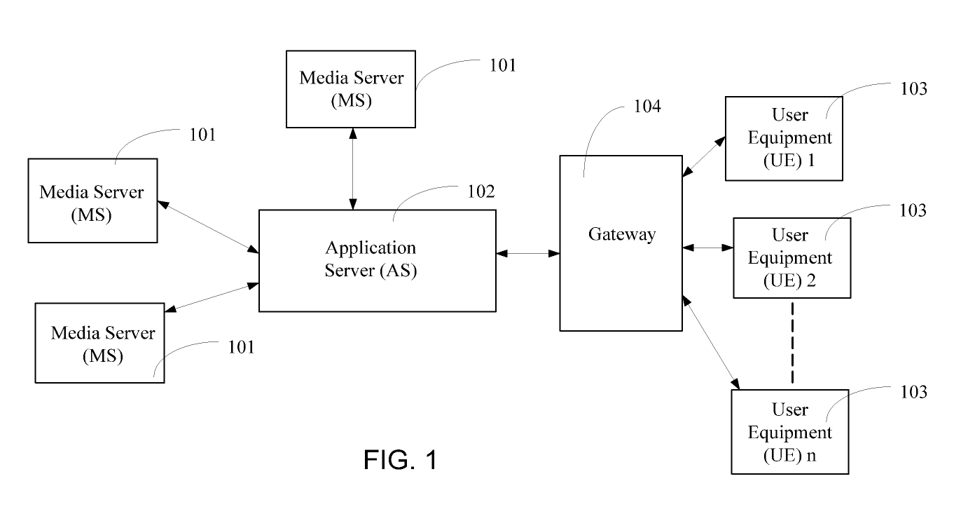

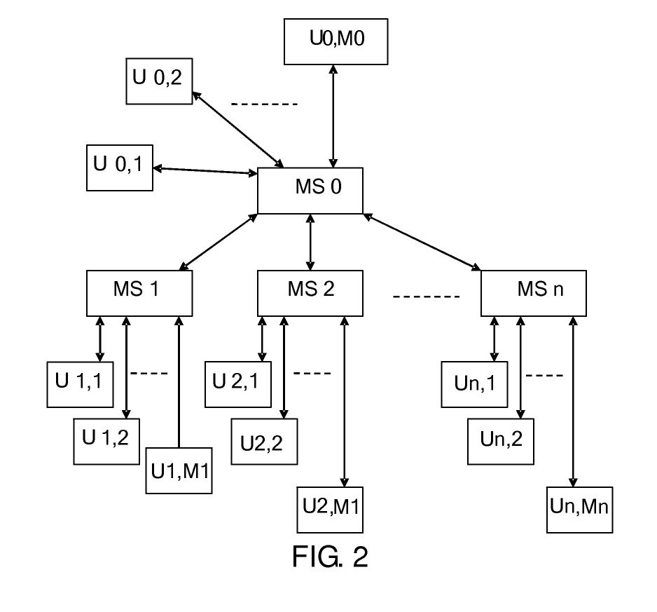

FIG. 2 shows an exemplary architecture of a concatenated audio conference system according to an embodiment of the present invention. When the size of the audio conference is large and a single MS has deficient resources for the audio conference, the SIP AS102 will allocate multiple MSs to the audio conference, for example, MS0 to MSn in FIG. 1, according to the size of the audio conference and the resource capacity on each MS. In the architecture, the MS0 is a root node, and a total of M0 UEs are allocated to the MS0. Therefore, M0 conference terminals are allocated on MS0. Meanwhile, n conference terminals are allocated on the MS0, corresponding to the leaf nodes MS1 to MSn. In this way, the MS0 occupies at least “M0+n” conference terminals. Besides, for the leaf node MS1 shown in FIG. 2, the SIP AS allocates M1 conference terminals corresponding to the UEs, and allocates one conference terminal for accessing the root node MS0. Other leaf nodes are similar. In this example, M0 and n are respectively natural number

A method for setting up audio conference connections is illustrated below with reference to the system architecture shown in FIG. 2. In this method, each leaf node MS in the conference needs to be connected with the root node MS0, and the UE allocated onto each MS needs to be connected with the MS that serves the UE.

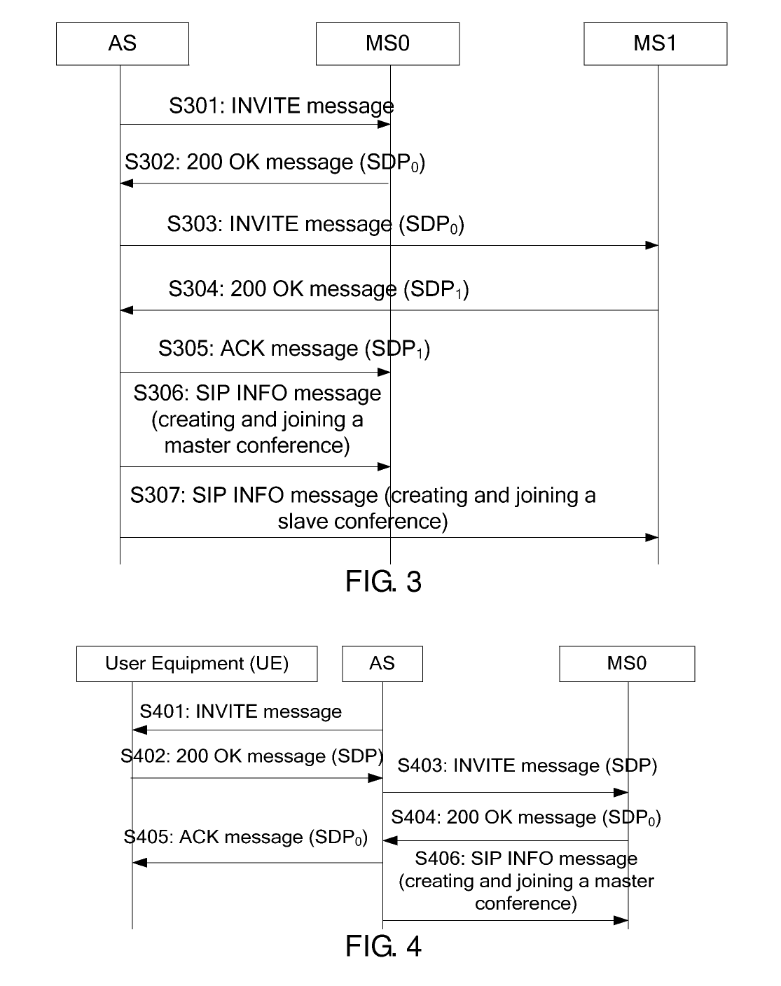

FIG. 3 is the flowchart of a method for setting up a concatenated audio conference between a root node and leaf nodes according to an embodiment of the present invention. The method for setting up a concatenated audio conference between a leaf node MS1 and a root node MS0 showed in the system shown in FIG. 2 includes the steps hereinafter.

S301: The SIP AS in the system sends an INVITE message to the root node MS0.

S302: After receiving the INVITE message, the MS0 creates a conference terminal T0, and allocates an IP port for receiving and another IP port for sending audio packets, to the conference terminal T0. Then the MS0 returns a 200 OK message to the SIP AS. The 200 OK message carries the SDP₀ information of the conference terminal T0. The SDP₀ information includes: IP address and port ID of the conference terminal T0 for receiving the audio packets, and type of media for processing.

S303: The SIP AS sends an INVITE message to the leaf node MS1. The INVITE message carries the SDP₀ information of the conference terminal T0.

S304: After receiving the INVITE message in the S303, the MS1 creates a conference terminal T1, and allocates an IP port for of receiving and another IP port for sending audio packets, to the conference terminal T1. Then the MS1 returns a 200 OK message to the SIP AS. The 200 OK message carries the SDP₁ information of the conference terminal T1. The SDP₁ information includes: IP address and port ID of the conference terminal T1 for receiving the audio packets, and type of media for processing.

S305: The SIP AS sends the SDP₁ information to the MS0 through an ACK (acknowledgement) message, notifying the MS0 of the information about the conference terminal allocated to the MS1. In this way, the two conference terminals T0 and T1 know the SDP information of each other, and can transmit data according to the SDP information of each other in the subsequent communication. By now, the connection for the audio conference has been set up.

S306: The SIP AS sends a SIP INFO (SIP media processing control language) message to the MS0, instructing the MS0 to create a master conference and add the conference terminal T0 into the created master conference.

S307: The SIP AS sends a SIP INFO message to the MS1, instructing the MS1 to create a slave conference and add the conference terminal T1 into the created slave conference. The method for creating a concatenated conference between other leaf nodes and the root node MS0 is similar and not repeated here any further.

The method described above is about setup of a concatenated audio conference between MSs. After required leaf node MSs are connected with the root node MS0, if the UEs on each MS are added into the conference, the whole audio conference is set up. The method for adding a UE into an MS is described below. FIG. 4 is an example flowchart of a method for setting up an audio conference connection between a UE with an MS according to an embodiment of the present invention. The method includes the steps hereinafter.

S401: The SIP AS sends an INVITE message to the UE.

S402: After going off-hook, the UE returns a 200 OK message that carries the SDP information of the UE to the SIP AS. The SDP information includes: IP address and port ID of the UE for receiving audio packets, and type of media for processing.

S403: The SIP AS sends an INVITE message to the MS. The INVITE message carries the SDP information of the UE.

S404: After receiving the INVITE message, the MS creates a conference terminal T0, and allocates an IP port for receiving and another IP port for sending audio packets, to the conference terminal T0. Then the MS returns a 200 OK message to the SIP AS. The 200 OK message carries the SDP₀ information of the conference terminal T0. The SDP₀ information includes: IP address and port ID of the conference terminal T0 for receiving the audio packets, and type of media for processing.

S405: The SIP AS sends an ACK message that carries the SDP₀ information of TO to the UE, notifying the UE of the information about the conference terminal T0 on the MS. In this way, the UE and the conference terminal know the SDP information of each other, and hence can communicate with each other according to the SDP information.

S406: The SIP AS sends a SIP INFO message to the MS, instructing the MS to add the conference terminal T0 into the corresponding master conference and slave conference. In this way, the UE connected with the conference terminal T0 is connected into the conference.

Besides, in step 406, if no master or slave conference is created on the MS, the SIP AS sends a SIP INFO message to the MS, instructing the MS to create a master or slave conference and add the conference terminal T0 into the created conference. Alternatively, SIP AS sends a first SIP INFO message for creating a master or slave conference first, instructing the MS to create a master or slave conference; and then sends a second SIP INFO message for joining the master or slave conference, instructing the MS to add the conference terminal T0 into the created conference. Commonly, the master conference is the conference which is initiated on a main media server at very first; the slave conference is established on a new media server when resources of the main media server turn short. An application server can control the slave conferences to add them into the master conference, which makes a large-scale conference.

In the previous embodiments, when the size of an audio conference is very large and a single MS has deficient resources for creating the conference, the SIP AS can distribute the UEs involved in the audio conference onto different MSs, connect the UEs on each MS with the MS in the way shown in FIG. 4, and concatenate the all leaf node MSs with the root node MS in the way shown in FIG. 3, thus adding all members into the audio conference.

The quantity of MSs allocated depends on the quantity of UEs involved in the conference and the quantity of ports available from each MS. A master conference is created on the root node MS, and a slave conference is created on each leaf node MS. On each leaf node MS, the SIP AS needs to not only allocate a conference terminal to the UE, but also allocate a conference terminal to the upper-level root node MS for joining the master conference of the root node MS. Likewise, on the root node MS, the SIP AS needs to not only allocate a conference terminal to the UE involved in the master conference, but also allocate a conference terminal to each leaf node involved in the master conference to ensure communication with each leaf node.

Note that in the embodiment shown in FIG. 3, the root node MS is instructed to create a conference terminal through 5301, and then in 5303, the leaf node MS is instructed to create a conference terminal associated with the conference terminal of the root node MS, thus setting up a connection between the root node MS and the leaf node MS. Alternatively, the method for setting up a connection between the root node MS and the leaf node MS may be: in S301′, instructing the leaf node MS to create a conference terminal, and then in S302′, sending the SDP information about the conference terminal created by the leaf node MS to the SIP AS through a 200 OK message; finally in S303′, instructing the root node MS to create a conference terminal associated with the conference terminal on the leaf node MS.

The previous embodiment is briefly known as static concatenation creation mode; namely, the UEs involved in the conference are constant. Therefore, an audio conference of the corresponding size can be created according to the quantity of UEs involved in the conference. Nevertheless, in the actual conference process, it is a dynamic mode alternatively. That is, if a new member wants to join the conference, the SIP AS will calculate out whether the MS involved in the conference has additional resources for creating a conference terminal. If additional resources are available, the SIP AS will allocate a conference terminal to the new UE on the MS with resources in the way shown in FIG. 4, and then add the conference terminal into the conference on the MS.

If there are more than one new UE that needs to join the conference but the resources in the MS are not enough for such UEs, the SIP AS will allocate a leaf node MS to the conference, and connect the new UEs with the newly allocated leaf node MS; and connect the newly allocated leaf node MS with the root node MS. The method for connecting the UE with the newly allocated leaf node MS is similar to the embodiment shown in FIG. 4, and the method for connecting the newly allocated leaf node MS with the root node MS is similar to the embodiment shown in FIG. 3.

Furthermore, if the SIP AS calculates and determines that the conference in the root node MS has no resource for adding the newly allocated leaf node MS, the SIP AS will divert a UE in the root node MS from the master conference to the slave conference before connecting the newly allocated leaf node MS to the root node. In this way, a conference terminal associated with the UE is spared for concatenation with the new MS. Afterward, the SIP AS connects the new MS with the root node MS of the conference to add the new UE. To put it simply, the method for adding new UEs into an existing concatenated audio conference is called “dynamic concatenation,” and the conference connected in this method is called a “dynamic concatenation conference.”

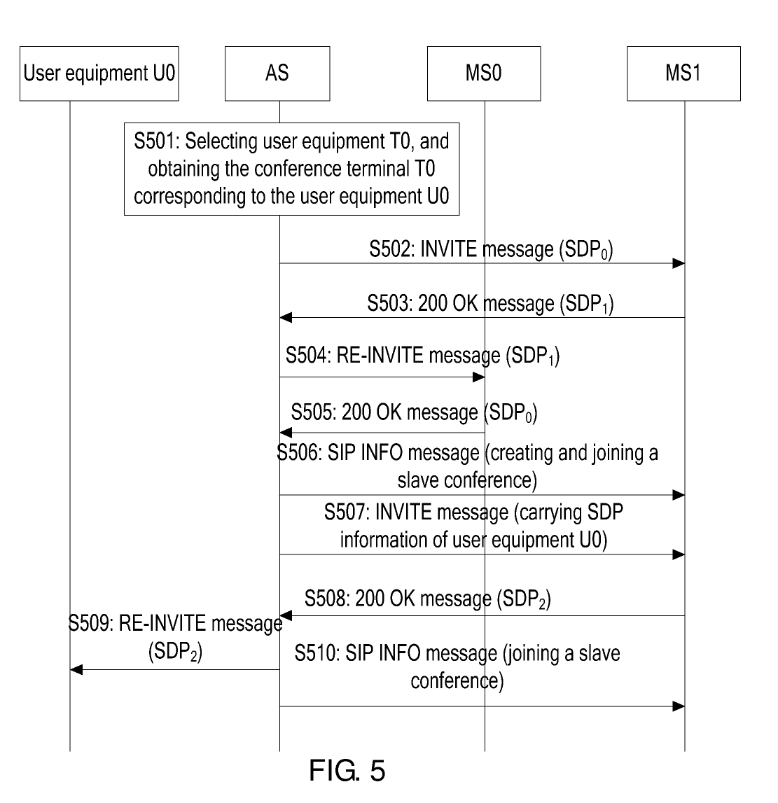

FIG. 5 shows an example flowchart of a dynamic concatenation method according to an embodiment of the present invention. If the conference in the MS has deficient resources for adding the new user equipment U1, and the embodiment includes the steps hereinafter.

S501: The SIP AS selects a user equipment U0 on the root node MS0, and obtains a conference terminal T0 corresponding to the user equipment U0 according to the corresponding relationship between the UE maintained by the SIP AS and the conference terminal on the MS0. The SIP AS can choose the UE in the mute state as the U0 preferably. Here, the “mute” means that it is forbidden to hear a sound.

S502: The SIP AS allocates a new leaf node MS1 to the conference, and sends the SDP₀ information of the conference terminal T0 on the MS0 to the MS1 through an INVITE message.

S503: After receiving the INVITE message, the MS1 creates a conference terminal T1, and allocates an IP port for the purposes of receiving and another IP port for sending audio packets, to the conference terminal T1. Then the MS1 returns a 200 OK message to the SIP AS. The 200 OK message carries the SDP₁ information of the conference terminal T1. The SDP₁ information includes: IP address and port ID of the conference terminal T1 for receiving the audio packets, and type of media for processing.

S504: The SIP AS sends a RE-INVITE message to the MS0, with the SDP₀ information of the conference terminal T1 carried in the message.

S505: The MS0 returns a 200 OK message to the SIP AS after receiving the RE-INVITE message. The 200 OK message carries the SDP₀ information of the conference terminal T0.

S506: The SIP AS sends a SIP INFO message to the MS, instructing the MS1 to create a slave conference and add the conference terminal T1 into the created slave conference.

S507: The SIP AS sends an INVITE message to the MS1, with the SDP information of the user equipment U0 carried in the message.

S508: After receiving the INVITE message in the S507, the MS1 creates a conference terminal T2, and sends the SDP₂ information of the conference terminal T2 to the SIP AS through a 200 OK message.

S509: After receiving the 200 OK message, the SIP AS sends a RE-INVITE message to the U0, with the SDP₂ information of the conference terminal T2 carried in the message.

S510: The SIP AS sends a SIP INFO message to the MS, instructing the MS1 to add the conference terminal T2 into the created slave conference.

Furthermore, in S502, before sending the INVITE message to the MS1, the SIP AS may send a BYE (terminate call) message to the MS0, instructing the MS0 to release the conference terminal T0. In this case, in S504, the SIP AS may send an INVITE message to the MS0 instead of the RE-INVITE message in S504, instructing the MS0 to create another conference terminal; and in S505, the 200 OK message returned to the SIP AS carries the SDP information of the newly created conference terminal. The INVITE message in S504 carries the SDP₁ information of the T1 allocated by the MS1.

In the previous embodiment, when a new member wants to join a conference but the MS of the conference has deficient resources, the SIP AS can switch the UE in the root node MS to the leaf node in order to release a certain amount of resources for connecting the new leaf node MS, and then add the new member UE into the conference through a new leaf node MS. In the previous embodiment, the conference size is expanded by adding new leaf node MSs. The embodiments of the present invention are easily operable, highly adaptable, and satisfy the conferences of various sizes to a great extent.

Furthermore, in the embodiment shown in FIG. 5, if the user equipment U0 in the root node MS0 is in the mute state, then in S506, the SIP AS may not only send a SIP INFO message to the MS1 for creating and joining a slave conference, but also send a SIP INFO message to the MS0 for canceling the mute state of the user equipment U0.

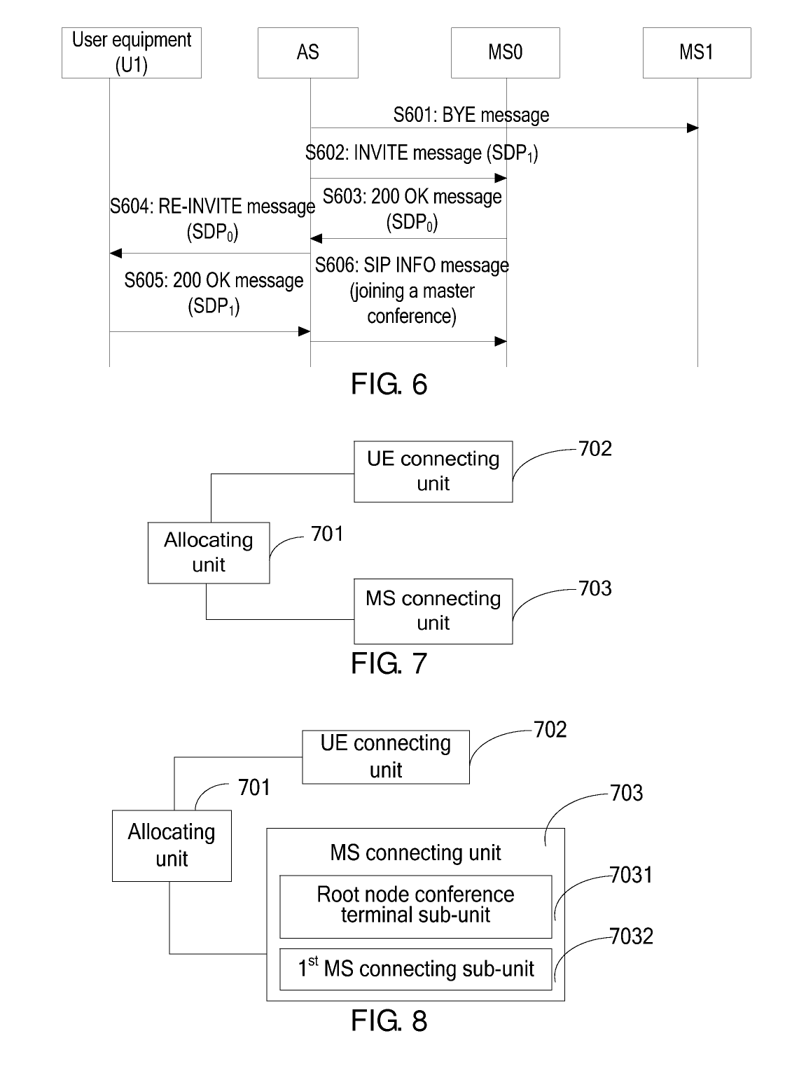

In some other embodiments of the present invention, the UE on the leaf node MS may be mute, and the speaking UE may be distributed on the root node MS, so as to avoid echo of the conference. Therefore, if a UE on the leaf node needs to speak, the UE must exit the slave conference on the leaf node MS and join the master conference on the root node MS. FIG. 6 is an example flowchart of a method for switching the UE from the mute state to the speaking state according to an embodiment of the present invention. In this embodiment, when the user equipment U1 on the leaf node MS1 is to be added to the root node MS0 for the purpose of speaking, the process of adding hereinafter occurs.

S601: The SIP AS sends a BYE message to the leaf node MS1, instructing the MS1 to release the resources of the conference terminal T1 for communication with the user equipment U1.

S602: The SIP AS sends an INVITE message to the root node MS0. The INVITE message carries the SDP₁ information of the user equipment U1.

S603: After receiving the INVITE message, the MS0 creates a conference terminal T0, and allocates an IP port for receiving and another IP port for sending audio packets, to the conference terminal T0. Then the MS0 returns a 200 OK message to the SIP AS. The 200 OK message carries the SDP₀ information of the conference terminal T0. The SDP₀ information includes: IP address and port ID of the conference terminal T0 for receiving the audio packets, and type of media for processing.

S604: The SIP AS sends a RE-INVITE message to the user equipment U1, with the SDP₀ information of the conference terminal T0 carried in the message.

S605: The U1 returns a 200 OK message to the SIP AS after receiving the RE-INVITE message. The 200 OK message carries the SDP₁ information of the user equipment U1.

S606: The SIP AS sends a SIP INFO message to the MS0, instructing the MS0 to add the conference terminal T0 into the master conference.

The previous embodiment is applicable to the circumstance that the resources on the root node MS0 are enough for adding a user equipment U1 into the conference. In other embodiments, if the resources on the root node MS0 are not enough, the SIP AS can take the steps shown in FIG. 5 after performing 5601 to add the UE into the master conference on the root node MS0.

In the previous embodiment, the sound (such as mute) can be set through a SIP INFO message. Furthermore, in other embodiments, the sound can be controlled through an INVITE message or a RE-INVITE message sent by the SIP AS. For example, the sound state can be set by changing the SDP information parameter in the INVITE or RE-INVITE message. Examples of such settings are: setting the IP in the “m=audio” line in the SDP information to “127.0.0.1,” or setting the port ID to “0” to indicate that the sound is “mute and dumb”; or, setting the attribute line “a” after the “m” line to “recvonly” to indicate “mute,” and setting the line “a” to “sendonly” to indicate “dumb”; or setting the line “a” to “sendonly” to indicate “speaking and non-mute.” The above examples for exemplary purposes only, and the actual settings are not limited to them. Here, the “mute” means that it is forbidden to hear a sound; the “dump” means that it is forbidden to send a sound.

It should be noted that the previous embodiments illustrate an implementation method under the SIP protocol, and the present invention are not limited to such embodiments. For example, in some other embodiments, the method can be implemented under MGCP protocol. If the MGCP protocol is applied, the differences from the previous SIP-based implementation are: In the MGCP protocol, the AS instructs the MS to create a conference terminal by sending a CRCX message in place of the INVITE message in the previous embodiment; when creating the first conference terminal for the conference, the conference ID is not generated by the AS, but is generated by the MS when the MS creates a conference terminal; the conference ID generated is notified to the AS through a 200 OK message, so that the AS can notify the conference ID to the MS through a CRCX message when the AS instructs the MS to create another conference terminal again in the future.

Furthermore, when the AS instructs the MS to add a conference terminal into a conference or set the sound state of the MS and the UE, the AS sends a MDCX message under the MGCP protocol in place of the SIP INFO message in the previous embodiment. When the AS instructs the MS to release resources, the AS under the MGCP protocol sends a DLCX message in place of the BYE message in the previous embodiment.

The embodiments of the present invention concatenate multiple MSs into a tree topology structure to form a master-slave conference and implement functions of a large conference without limiting the UE quantity in the case that a single MS is not enough, thus solving the inability of convening large conferences reliably in conventional systems for deficiency of MSs in the operation environment. The user can operate the conference on a large integrated virtual MS regardless of the conference size and the quantity of MSs on which the conference is distributed. The operators can deploy the MSs of a proper quantity according to the scale of the concurrent users. The existing MSs can be integrated into the technical solution under the present invention regardless of the manufacturer, only if they provide standard interfaces and capacity parameters. This also slashes the equipment cost greatly.

Based on the previous technical solution, an apparatus for setting up audio conference connections is disclosed according to some embodiments of the present invention. The apparatus can be integrated onto an application server such as SIP AS. When the resources of a single MS are not enough for supporting the whole audio conference, two or more MSs can be concatenated according to the quantity of UEs involved in the audio conference, so that all UEs that need to join the conference can be added into the conference. FIG. 7 shows the structure of an apparatus for setting up an audio conference connection. The apparatus includes:

an allocating unit 701, adapted to allocate at least two Media Servers (MSs), dependent on the quantity of the UEs involved in the audio conference; and select one of the MSs as a root node MS, with the remaining MSs as leaf node MSs, wherein the quantity of the allocated MSs depends on the size of the audio conference and the resource capacity of each MS;

a UE connecting unit 702, adapted to distribute the UEs onto MSs allocated by the allocating unit 701, and set up a connection between each UE and the MS that serves the UE, wherein: UE connecting units 702 can allocate the UEs ready to speak onto the root node MS and allocate other UEs not ready to speak onto the leaf node MSs; the connection between the UE and the MS is set up by creating a conference terminal associated with the UE on the MS to accomplish a connection with the conference terminal;

an MS connecting unit 703, adapted to set up a connection between every leaf node MS in the allocating unit 701 and the root node MS. Every MS connecting unit 703 can instruct to create an associated conference terminal on the root node MS and the leaf node MS respectively, and implement connection between the root node MS and the leaf node MS through communication between the conference terminals.

The process of creating an associated conference terminal on the root node MS and the leaf node MS respectively may be embodied as different modes: one of the modes, instructing the leaf node MS to create a conference terminal associated with the conference terminal on the root node MS, or further instructing the root node MS to create a conference terminal associated with the conference terminal on the leaf node. The apparatuses corresponding to those two modes are described below with reference to accompanying drawings.

FIG. 8 shows an example structure of an MS connecting unit 703 according to an embodiment of the present invention, wherein the MS connecting unit 703 may instruct the leaf node MS to create a conference terminal T1 associated with the conference terminal T0 on the root node MS. On the basis of the apparatus shown in FIG. 7, the MS connecting unit 703 includes: a root node conference terminal sub-unit 7031, and a first MS connecting sub-unit 7032, wherein:

the root node conference terminal sub-unit 7031 is adapted to send an INVITE message to the root node MS in the allocating unit 701, instructing the root node MS to create a conference terminal T0;

the first MS connecting sub-unit 7032 is adapted to send an INVITE message to the leaf node MS in the allocating unit 701 after receiving a response message from the root node MS; the INVITE message includes SDP₀ information of the conference terminal T0 created by the root node MS, for the purpose of instructing the leaf node MS to create a conference terminal T1 associated with the conference terminal T0 of the root node MS according to the SDP₀ information. In this way, the two conference terminals T0 and T1 know the SDP information of each other, and can transmit data according to the SDP information of each other in the subsequent communication. The SDP information includes: IP address and port ID of the conference terminal for receiving the audio packets, and type of media for processing.

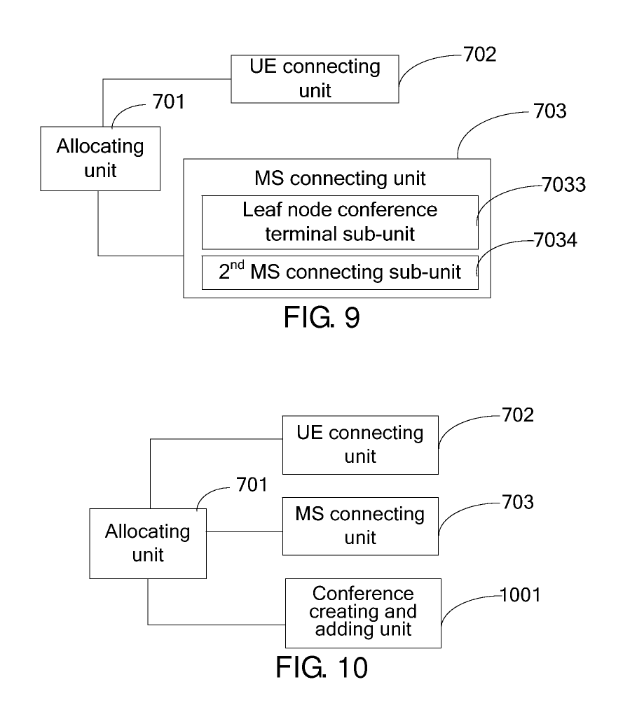

FIG. 9 shows another structure of an MS connecting unit 703 shown in FIG. 7, wherein the MS connecting unit 703 may instruct the root node MS to create a conference terminal T0 associated with the conference terminal T1 on the leaf node MS. On the basis of the apparatus shown in FIG. 7, the MS connecting unit 703 includes: a leaf node conference terminal sub-unit 7033, and a second MS connecting sub-unit 7034, wherein:

the leaf node conference terminal sub-unit 7033 is adapted to send an INVITE message to the leaf node MS in the allocating unit 701, instructing the leaf node MS to create a conference terminal T1;

the second MS connecting sub-unit 7034 is adapted to send an INVITE message to the root node MS in the allocating unit 701 after receiving a response message from the leaf node MS; the INVITE message includes SDP1 information of the conference terminal T1 created by the leaf node MS, for the purpose of instructing the root node MS to create a conference terminal T0 associated with the conference terminal T1 of the leaf node MS according to the SDP1 information. In this way, the two conference terminals T0 and T1 know the SDP information of each other, and can transmit data according to the SDP information of each other in the subsequent communication. The SDP information includes: IP address and port ID of the conference terminal for receiving the audio packets, and type of media for processing.

The previous embodiments of the apparatus are specific to the static concatenation mode. Nevertheless, in the conference process, if a new member wants to join the conference, the apparatus will calculate out whether the MS involved in the conference has additional resources for creating a conference terminal. If additional resources are available, the UE connecting unit 702 of this apparatus will allocate a conference terminal to the new UE on the MS with available resources to connect the new UE with the MS that serves the conference.

Furthermore, when the UE or leaf node MS connected with the root node MS or the UE connected with the leaf node MS is not added into the conference, the apparatus can be further used to add the UE or leaf node into the conference. FIG. 10 shows the architecture of another apparatus for setting up an audio conference connection according to an embodiment of the present invention. On the basis of the apparatus shown in FIG. 7, this apparatus can include:

a conference creating and adding unit 1001, adapted to create a master conference of the audio conference on the root node MS in the allocating unit 701; add the conference terminal on the root node MS into the master conference; create a slave conference of the audio conference on each leaf node MS in the allocating unit 701; and add the conference terminal on each leaf node MS into the slave conference.

For example, the conference creating unit 1001 can send a SIP INFO message to the root node MS, instructing the root node MS to create a master conference and add the conference terminal on the root node MS into the created master conference. The conference creating unit 1001 can send a SIP INFO message to the leaf node MS, instructing the leaf node MS to create a slave conference and add the conference terminal on the leaf node MS into the created slave conference.

Furthermore, the conference creating unit 1001 and the conference adding unit 1002 shown in FIG. 10 are applied not only to the apparatus shown in FIG. 7, but also to the apparatus shown in FIG. 8 or FIG. 9, with the connection relations being the same as that shown in FIG. 10.

The apparatuses described above are for illustration only. The unit described above as a separate component may be or may not be physically separated; the component displayed as a unit may be or may not be a physical unit; the components can be located in a place or distributed onto multiple network units. The users can select part or all of the modules according to their own needs to fulfill the purposes of the embodiments of the present invention. Ordinary technicians in this field can understand and implement the technical solutions without making any creative effort.

After study of the above embodiments, technicians in this field should understand that the invention may be realized through software and general hardware platforms or through hardware only. In most cases, software plus general hardware platforms is a better way. Based on such understandings, the technical solution provided in embodiments of the invention or contributions to conventional systems art can be embodied in software products. The software is stored in a storage medium (for example, ROM/RAM, disk, and CD) and incorporates several instructions to instruct a computer device (for example, PC, server, or network device) to execute the method provided in the embodiments of the present invention.

After study of the above embodiments, technicians in this field should understand that the invention may be realized through software and general hardware platforms or through hardware only. In most cases, software plus general hardware platforms is a better way. Based on such understandings, the technical solution provided in embodiments of the invention or contributions to conventional systems can be embodied in software products. The software is stored in a storage medium (for example, ROM/RAM, disk, and CD) and incorporates several instructions to instruct a computer device (for example, PC, server, or network device) to execute the method provided in the embodiments of the present invention.

The embodiments described above are only better ones of this invention, and they are not used to confine the protection scope of this invention. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for establishing communication of audio conference, comprising:
allocating at least two Media Servers (MSs) according to the quantity of terminals involved in an audio conference;
selecting one MS from the at least two MSs as a root node MS, and the remaining MS(s) as leaf node MS;
establishing communication between the root node MS and the leaf node MS(s); and
establishing communication between a terminal and the MS served for the terminal;
wherein the process of establishing communication between a terminal and the MS served for the terminal further comprises:
establishing communication between the terminal that needs to speak and the root node MS; and establishing communication between the terminal that needs not to speak and the leaf node MS.

2. The method according to claim 1, wherein the process of establishing communication between the root node MS and the leaf node MS(s) further comprises:
establishing conference terminals in the root node MS, wherein the quantity of the conference terminals in the root node MS is the same as that of the leaf node MS(s), and each conference terminal in the root node MS communicates respectively with a leaf node MS;
notifying Session Description Protocol information of the conference terminal in the root node MS to the corresponding leaf node MS respectively;
establishing conference terminal in every one of the leaf node MS(s), wherein the conference terminal in the every one of the leaf node MS(s) communicates respectively with the corresponding conference terminal in the root node MS; and
notifying Session Description Protocol information of the conference terminal in the every one of the leaf node MS(s) to the root node MS; wherein the Session Description Protocol information comprises IP address, port quantity, and type for processing media, for receiving audio data packages by the conference terminals.

3. The method according to claim 1, wherein the process of establishing communication between the root node MS and the leaf node MS(s) further comprises:
establishing conference terminal in every one of the leaf node MS(s), wherein the conference terminal in the every one of the leaf node MS(s) is communicated respectively with the root node MS;
notifying Session Description Protocol information of the conference terminals in the leaf node MS(s) to the root node MS;
establishing conference terminals in the root node MS, wherein the conference terminals in the root node MS communicate respectively with the corresponding conference terminals in the leaf node MS(s); and
notifying Session Description Protocol information of the conference terminals in the root node MS to the corresponding leaf node MS; wherein the Session Description Protocol information comprises IP address, port quantity, and type for processing media, for receiving audio data package by the conference terminals.

4. The method according to claim 1, further comprising:
establishing a master conference of the audio conference on the root node MS and a slave conference of the audio conference on every leaf node MS;
enabling the conference terminals of the root node MS to join in the master conference; and
enabling the every conference terminal of the leaf node MSs to join in the slave conference of corresponding leaf node MS.

5. The method according to claim 1, further comprising:
determining whether the root node MS has resource for communicating with a new leaf node MS when a new terminal joins in the audio conference;
establishing the communication between the new leaf node MS and the root node MS if the root node MS has the resource; and
establishing the communication between the new terminal and the new leaf node MS.

6. The method according to claim 5, further comprising:
transferring a terminal of the root node MS from the master conference on the root node MS to the slave conference on a leaf node MS when the root node MS has no the resource, so as to save resource;
establishing communication between a new leaf node MS and the root node MS by using the saved resource; and
establishing communication between a new terminal and the new leaf node MS.

7. The method according to claim 4, further comprising: if a terminal on the leaf node needs to speak, exiting, by the terminal, the slave conference on the leaf node MS and joining by the terminal, the master conference on the root node MS.

8. An apparatus for establishing communication of audio conference, comprising:
an allocating unit, adapted to allocate at least two Media Servers, MSs, according to the quantity of terminals involved in an audio conference, and select one MS from the at least two MSs as a root node MS, and the remaining MS(s) as leaf node MS;
a terminal communication unit, adapted to establish communication between a terminal and an MS served for the terminal; and
an MS communication unit, adapted to establish communication between the root node MS and the leaf node MS(s); wherein the terminal communication unit allocates terminals ready to speak onto the root node MS and allocates other terminals not ready to speak onto the leaf node MS.

9. The apparatus according to claim 8, wherein the MS communication unit further comprises:
a root node conference terminal sub-unit, adapted to send a first message to the root node MS, in order to indicate the root node MS to establish conference terminals;
an MS communication sub-unit, adapted to send a second message comprising Session Description Protocol information of the conference terminal established by the root node MS to a leaf node MS, in order to indicate the leaf node MS to establish, according to the Session Description Protocol information, a conference terminal.

10. The apparatus according to claim 8, wherein the MS communication unit further comprises:
a leaf node conference terminal sub-unit, adapted to send a third message to a leaf node MS, in order to indicate the leaf node MS to establish a conference terminal;
an MS communication sub-unit, adapted to send a fourth message comprising Session Description Protocol information of the conference terminal established by the leaf node MS to the root node MS, in order to indicate the root node MS to establish, according to the Session Description Protocol information, a conference terminal.

11. The apparatus according to claim 8, wherein the apparatus further comprises:
a conference establishing and joining unit, adapted to establish a master conference of the audio conference in the root node MS, enable conference terminals of the root node MS join in the master conference, establish a slave conference of the audio conference in the every leaf node MS, and enable a conference terminal of the every leaf node MS join in corresponding slave conference.

12. A computer program product, comprising computer program codes, which, when executed by a computer unit, cause the computer unit perform a method including:
allocating at least two Media Servers (MSs) according to the quantity of terminals involved in an audio conference;
selecting one MS from the at least two MSs as a root node MS, and the remaining MS(s) as leaf node MS;
establishing communication between the root node MS and the leaf node MS(s); and
establishing communication between a terminal and the MS served for the terminal;
wherein the process of establishing communication between a terminal and the MS served for the terminal further comprises:
establishing communication between the terminal that needs to speak and the root node MS; and establishing communication between the terminal that needs not to speak and the leaf node MS.

13. The computer program product according to claim 12, wherein the comprising computer program codes cause the computer unit further perform:
establishing conference terminals in the root node MS, wherein the quantity of the conference terminals in the root node MS is the same as that of the leaf node MS(s), and each conference terminal in the root node MS communicates respectively with a leaf node MS;
notifying Session Description Protocol information of the conference terminal in the root node MS to the corresponding leaf node MS respectively;
establishing conference terminal in every one of the leaf node MS(s), wherein the conference terminal in the every one of the leaf node MS(s) communicates respectively with the corresponding conference terminal in the root node MS; and
notifying Session Description Protocol information of the conference terminal in the every one of the leaf node MS(s) to the root node MS; wherein the Session Description Protocol information comprises IP address, port quantity, and type for processing media, for receiving audio data packages by the conference terminals.

14. The computer program product according to claim 12, wherein the computer program codes cause the computer unit further perform:
establishing conference terminal in every one of the leaf node MS(s), wherein the conference terminal in the every one of the leaf node MS(s) is communicated respectively with the root node MS;
notifying Session Description Protocol information of the conference terminals in the leaf node MS(s) to the root node MS;
establishing conference terminals in the root node MS, wherein the conference terminals in the root node MS communicate respectively with the corresponding conference terminals in the leaf node MS(s); and
notifying Session Description Protocol information of the conference terminals in the root node MS to the corresponding leaf node MS; wherein the Session Description Protocol information comprises IP address, port quantity, and type for processing media, for receiving audio data package by the conference terminals.

15. The computer program product according to claim 12, wherein the computer program codes cause the computer unit further perform:
establishing a master conference of the audio conference on the root node MS and a slave conference of the audio conference on every leaf node MS;
enabling the conference terminals of the root node MS to join in the master conference; and
enabling the every conference terminal of the leaf node MSs to join in the slave conference of corresponding leaf node MS.

16. The computer program product according to claim 12, wherein the computer program codes cause the computer unit further perform:
leaf node MS when a new terminal joins in the audio conference;
establishing the communication between the new leaf node MS and the root node MS if the root node MS has the resource; and
establishing the communication between the new terminal and the new leaf node MS.

17. The computer program product according to claim 12, wherein the computer program codes cause the computer unit further perform:
transferring a terminal of the root node MS from the master conference on the root node MS to the slave conference on a leaf node MS when the root node MS has no the resource, so as to save resource;
establishing communication between a new leaf node MS and the root node MS by using the saved resource; and
establishing communication between a new terminal and the new leaf node MS.

18. The computer program product according to claim 12, wherein the computer program codes cause the computer unit further perform: if a terminal on the leaf node needs to speak, exiting, by the terminal, the slave conference on the leaf node MS and joining by the terminal, the master conference on the root node MS.
